(19) United States
(12) Patent Application Publication
(10) Pub. No.: US 2012/0281861 A1
(43) Pub. Date: Nov. 8, 2012

(54) VIBRATION DIAPHRAGM AND SPEAKER WITH A VIBRATION DIAPHRAGM

(76) Inventor: Steff Lin, Taipei (TW)

(21) Appl. No.: 13/420,817

(22) Filed: Mar. 15, 2012

(30) Foreign Application Priority Data
May 6, 2011 (TW) 100208079

(51) Int. Cl. H04R 1/00; H04R 7/02

(52) U.S. Cl. 381/182; 381/396; 181/173

(57) ABSTRACT

A vibration diaphragm for a speaker has a spherical bowl section, an annular intervening section and an annular outer section. The spherical bowl section has a top and a spherical cavity defined in the top. The annular intervening section is formed on and protrudes radially outward from the spherical bowl section. A bending line is formed on a boundary between the spherical bowl section and the annular intervening section. An annular outer section is formed on and protrudes radially from the annular intervening section and extends obliquely outward in a direction along which the cavity is sunk, wherein a bending line is formed on a boundary between the annular intervening section and the annular outer section, and an obtuse angle is defined between the annular intervening section and annular outer section.

### BACKGROUND OF THE INVENTION

1. Field of the Invention

The present invention relates to a vibration diaphragm, and more particularly to a vibration diaphragm that is mounted on a speaker and has a spherical surface area, an intervening annular area and an outer annular area. The vibration diaphragm has an improved rigidity.

2. Description of Related Art

A conventional speaker comprises a frame, a magnet, a coil and a diaphragm. The magnet is mounted on the frame. The coil is located around one of the magnetic poles of the magnet and is selectively electrified. The diaphragm is mounted on the frame and is connected to the coil. When electrified, the coil generates a magnetic field to interact with a magnetic field of the magnet so that the coil and the diaphragm are vibrated. The vibrating diaphragm causes sound wave.

Improved speakers that are more compact are developed for being mounted in automobiles or embedded in walls. However, compactness of a volume of the speaker is limited by the diaphragm. The diaphragm is required to have sufficient rigidity in order to provide regular vibration. Insufficient rigidity of the diaphragm leads to undesirably irregular vibration negatively affecting sound quality of the speaker. Therefore, the diaphragm is made with a basin-shaped configuration that has a certain cavity depth for improving the rigidity of the diaphragm. However the basin-shaped diaphragm with a considerable cavity depth disadvantages compactness thereof.

To further improve the rigidity of the diaphragm, additional wires are attached to the diaphragm or high polymer material is employed to manufacture the diaphragm. However, the basin-shaped configuration is not changed and still limits the compactness of the diaphragm.

To overcome the shortcomings, the present invention provides a vibration diaphragm and a speaker with a vibration diaphragm to mitigate or obviate the aforementioned problems.

### SUMMARY OF THE INVENTION

The main objective of the invention is to provide a vibration diaphragm that is mounted on a speaker and has a spherical surface area, an intervening annular area and an outer annular area. The vibration diaphragm has an improved rigidity.

A vibration diaphragm for a speaker in accordance with the present invention comprises a spherical bowl section, an annular intervening section and an annular outer section. The spherical bowl section has a top and a spherical cavity defined in the top. The annular intervening section is formed on and protrudes radially outward from the spherical bowl section. A bending line is formed on a boundary between the spherical bowl section and the annular intervening section. An annular outer section is formed on and protrudes radially from the annular intervening section and extends obliquely outward in a direction along which the cavity is sunk, wherein a bending line is formed on a boundary between the annular intervening section and the annular outer section, and an obtuse angle is defined between the annular intervening section and annular outer section.

Other objectives, advantages and novel features of the invention will become more apparent from the following detailed description when taken in conjunction with the accompanying drawings.

### BRIEF DESCRIPTION OF THE DRAWINGS

FIG. 1 is a side cross sectional view of a vibration diaphragm for a speaker in accordance with the present invention;

FIG. 2 is an exploded perspective view of the vibration diaphragm in FIG. 1;

FIG. 3 is a perspective view in partial section of an outer layer of the diaphragm in FIG. 1;

FIG. 4 is an exploded perspective view of a speaker with the diaphragm in FIG. 1; and

FIG. 5 is a side view of the speaker in FIG. 4.

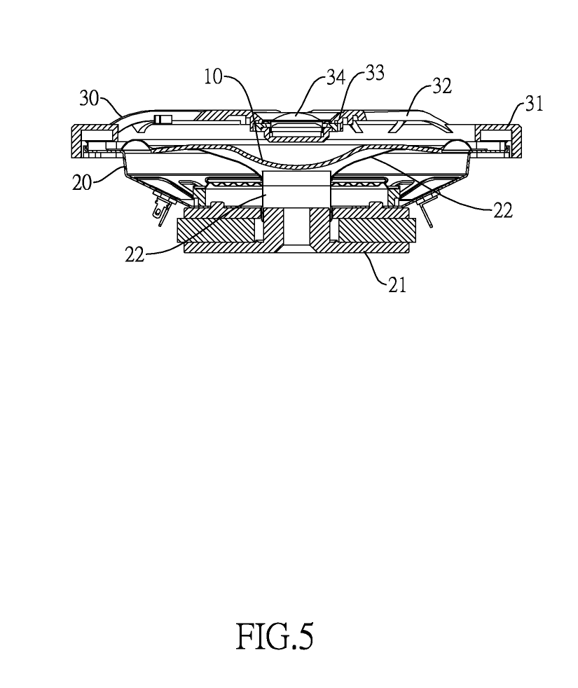

### DETAILED DESCRIPTION OF THE PREFERRED EMBODIMENT

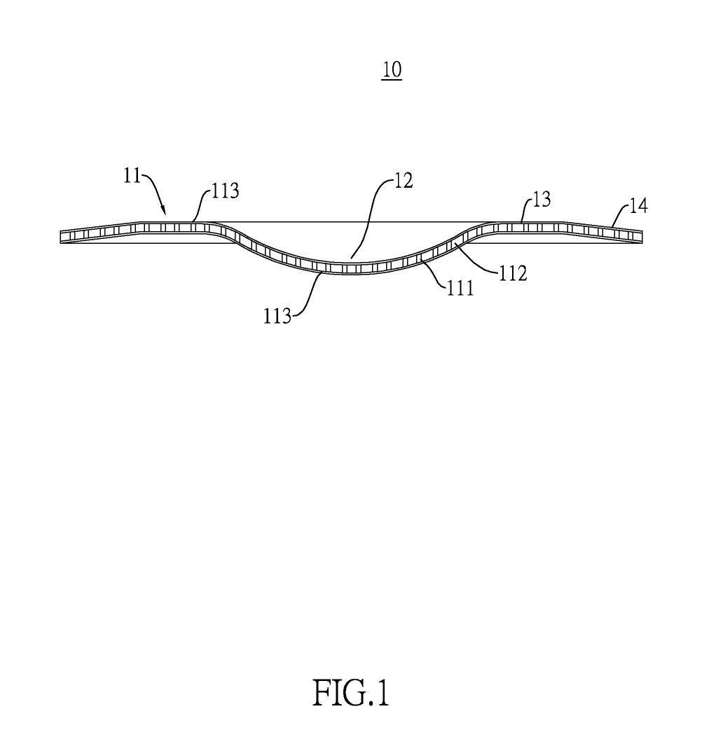

With reference to FIG. 1, a vibration diaphragm 10 for a speaker in accordance with the present invention comprises a circular board body 11 being sufficiently thin and having a spherical bowl section 12, an annular intervening section 13 and an annular outer section 14.

The spherical bowl section 12 has a top and a spherical cavity defined in the top.

The annular intervening section 13 is a ring-shaped board, may have a flat outer surface without any recesses or protrusions, and is formed on and protrudes radially and horizontally outward from the spherical bowl section 12. A bending line is formed on a boundary between the spherical bowl section 12 and the annular intervening section 13 to improve rigidity of the vibration diaphragm 10.

The annular outer section 14 is a ring-shaped board, may have a flat outer surface without any recesses or protrusions, and is formed on and protrudes radially from the annular intervening section 13 and extends obliquely outward in a direction along which the cavity is sunk. A bending line is formed on a boundary between the annular intervening section 13 and the annular outer section 14 to improve the rigidity of the vibration diaphragm 10. Furthermore, an obtuse angle is defined between the annular intervening section 13 and annular outer section 14.

Preferably, an area of the spherical bowl section 12 is about one-third of an area of the circular board body 11. The annular intervening section 13 or annular outer section 14 may further have recessed portions to increase the rigidity of the vibration diaphragm.

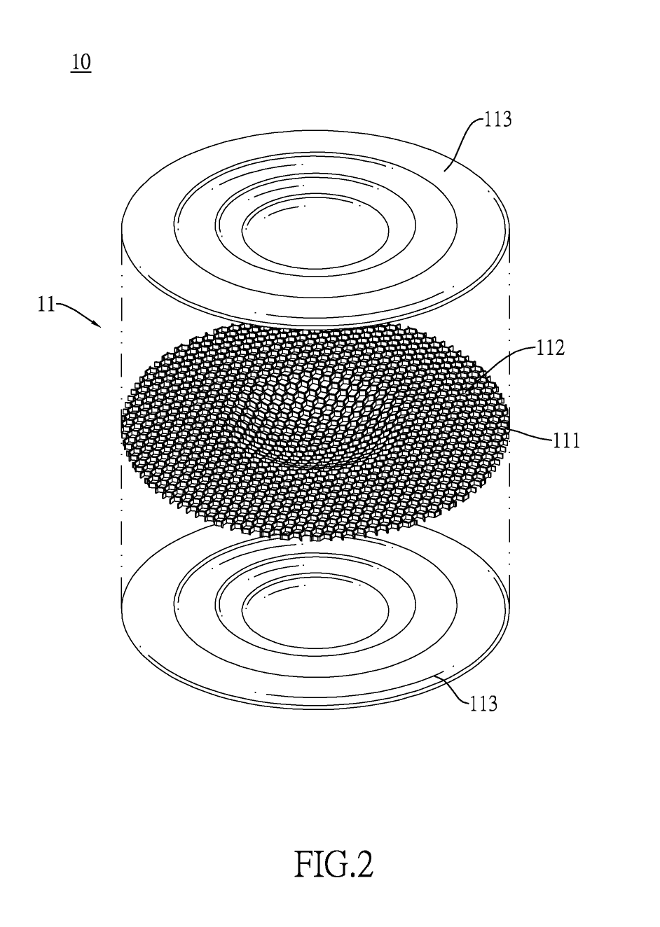

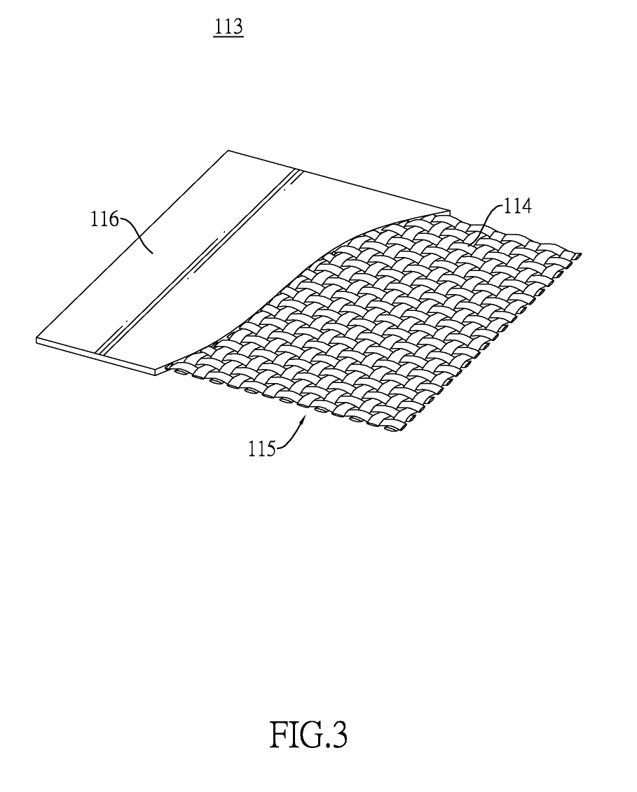

With further reference to FIGS. 2 and 3, the circular board body 11 is formed from a supporting layer 111 and two outer layers 113.

The supporting layer 111 has a top surface, a bottom surface and multiple regular hexagonal and honeycomb through holes 112 defined vertically through the supporting layer 111 and arranged orderly to provide light weight and high rigidity.

The outer layers 113 are mounted respectively on the top and bottom surfaces of the supporting layer 111 by glue. Each outer layer 113 has a reinforcing layer 115 and an encapsulating covering 116. The reinforcing layer 115 is woven by fibers 114. The encapsulating covering 116 encapsulates the reinforcing layer 115. The vibration diaphragm 10 formed from the supporting 111 and outer layers 113 is lightweight and structurally firm.

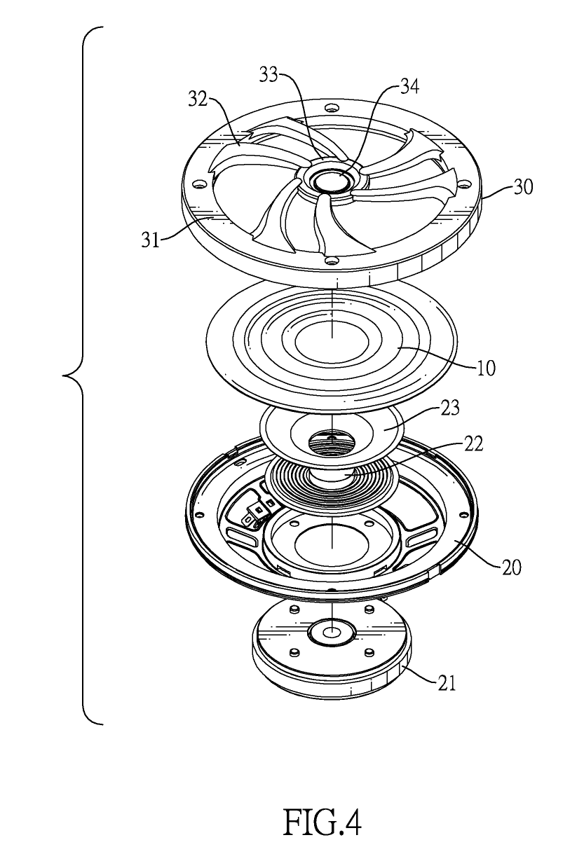

With further reference to FIGS. 4, a speaker in accordance with the present invention comprises a frame 20, a magnet 21, a coil 22, a vibration conveyer 23, a vibration diaphragm 10 and a cover 30.

The frame 20 has a front and a bottom.

The magnet 21 is mounted on the bottom of the frame 20 and has two opposite magnetic poles.

The coil 22 is suspended above one of the magnetic poles of the magnet 21 and is selectively electrified according to sound signals from an electrical music player to generate a magnetic field interacting with a magnetic field of the magnet 21 to vibrate.

The vibration conveyer 23 is connected to the coil 22 and is selectively vibrated by the coil 22.

The vibration diaphragm 10, as aforementioned, is mounted on the top of the frame 20, is connected to the vibration conveyer 23 and is selectively vibrated by the vibration conveyer 23.

The cover 30 is mounted securely on the top of the frame 20, covers the vibration diaphragm 10 and has a rim 31, multiple spokes 32, a hub 33 and a sub-speaker 34.

The rim 31 is annular and is mounted securely on top of the frame 20.

The spokes 32 are formed on and protrude radially inward from the rim 31 and each spoke 32 has an inner end.

The hub 33 is connected to the inner ends of the spokes 32.

The sub-speaker 34 is mounted on the hub 33, is located in or aligns with the cavity of the spherical bowl section 12 of the vibration diaphragm 10 and has a sound range that is different from a sound range of the speaker. The sub-speaker 34 located in the cavity of the vibration diaphragm 10 does not increase the volume of the whole speaker and enhances a total voice.

Each bending line between adjacent two of the spherical bowl section 12, the annular intervening section 13 and the annular outer section 14 efficiently improves the rigidity of the vibration diaphragm 10 so that a depth of the cavity of the spherical bowl section 12 may be reduced to make the vibration diaphragm 10 more compact when compared to conventional diaphragms.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A vibration diaphragm for a speaker, the vibration diaphragm comprising:
a spherical bowl section having a top and a spherical cavity defined in the top;
an annular intervening section being formed on and protruding radially outward from the spherical bowl section, wherein a bending line is formed on a boundary between the spherical bowl section and the annular intervening section; and
an annular outer section formed on and protruding radially from the annular intervening section and extending obliquely outward in a direction along which the cavity is sunk, wherein a bending line is formed on a boundary between the annular intervening section and the annular outer section, and an obtuse angle is defined between the annular intervening section and annular outer section.

2. The vibration diaphragm as claimed in claim 1, wherein an area of the spherical bowl section is about one-third of an area of the circular board body.

3. The vibration diaphragm as claimed in claim 1, wherein
the annular intervening section has a flat outer surface; and
the annular outer section has a flat outer surface.

4. The vibration diaphragm as claimed in claim 1, wherein
the circular board body is formed from a supporting layer and two outer layers;
the supporting layer has a top surface, a bottom surface and multiple through holes defined vertically through the supporting layer to provide light weight and high rigidity; and
the outer layers are mounted respectively on the top and bottom surfaces of the supporting layer.

5. The vibration diaphragm as claimed in claim 4, wherein
the through holes of the supporting layer are regular hexagonal and arranged orderly; and
each outer layer has
a reinforcing layer woven by fibers; and
an encapsulating covering encapsulating the reinforcing layer.

6. A speaker comprising:
a frame having a front and a bottom;
a magnet mounted on the bottom of the frame and having two opposite magnetic poles;
a coil suspended above one of the magnetic poles of the magnet and selectively electrified to generate a magnetic field interacting with a magnetic field of the magnet to vibrate;
a vibration conveyer connected to the coil and selectively vibrated by the coil;
a vibration diaphragm mounted on the top of the frame, connected to the vibration conveyer, selectively vibrated by the vibration conveyer and having a spherical bowl section having a top and a spherical cavity defined in the top;
an annular intervening section being formed on and protruding radially outward from the spherical bowl section, wherein a bending line is formed on a boundary between the spherical bowl section and the annular intervening section; and
an annular outer section formed on and protruding radially from the annular intervening section and extending obliquely outward in a direction along which the cavity is sunk, wherein a bending line is formed on a boundary between the annular intervening section and the annular outer section, and an obtuse angle is defined between the annular intervening section and annular outer section.

7. The speaker as claimed in claim 6 further comprising a cover mounted securely on the top of the frame, covering the vibration diaphragm and having
a rim being annular and mounted securely on top of the frame;
multiple spokes formed on and protruding radially inward from the rim and each spoke having an inner end;
a hub connected to the inner ends of the spokes; and
a sub-speaker mounted on the hub, located in the cavity of the spherical bowl section of the vibration diaphragm and having a sound range that is different from a sound range of the speaker.

8. The speaker as claimed in claim 6, wherein an area of the spherical bowl section is about one-third of an area of the circular board body.

9. The speaker as claimed in claim 6, wherein
the annular intervening section has a flat outer surface; and
the annular outer section has a flat outer surface.

10. The speaker as claimed in claim 6, wherein
the circular board body is formed from a supporting layer and two outer layers;
the supporting layer has a top surface, a bottom surface and multiple through holes defined vertically through the supporting layer to provide light weight and high rigidity;
the outer layers are mounted respectively on the top and bottom surfaces of the supporting layer;
the through holes of the supporting layer are regular hexagonal and arranged orderly; and
each outer layer has
a reinforcing layer woven by fibers; and
an encapsulating covering encapsulating the reinforcing layer.
